(19) United States
(12) Patent Application Publication
(10) Pub. No.: US 2021/0370116 A1
(43) Pub. Date: Dec. 2, 2021

(54) STREAM-WISE VORTEX FIRE EXTINGUISHER

(71) Applicant: UNIVERSITY OF WASHINGTON, Seattle, WA (US)

(72) Inventors: Giovanni Nino, Seattle, WA (US); Hilary Lawlor, Seattle, WA (US); Fiona Spencer, Seattle, WA (US); Robert E. Breidenthal, Seattle, WA (US); DuyKhang Nguyen, Seattle, WA (US)

(21) Appl. No.: 17/334,364

(22) Filed: May 28, 2021

Related U.S. Application Data
(60) Provisional application No. 63/033,032, filed on Jun. 1, 2020.

(51) Int. Cl. A62C 99/00; B05B 1/34

(52) U.S. Cl. CPC A62C 99/0009; B05B 1/341

(57) ABSTRACT

Devices, systems, and methods for extinguishing fires are provided. A device for extinguishing fires may include a nozzle defining a flow channel. The device may include a convector fluidly coupled with the flow channel and configured to introduce a flow through the flow channel. The device may also include a vortex generator disposed within the nozzle, the vortex generator positioned to interact with the flow and to form a stream-wise vortex external to the nozzle.

### CROSS-REFERENCE TO RELATED APPLICATION

This application claims the benefit of provisional application No. 63/033,032, entitled “FIRE EXTINGUISHER,” filed on Jun. 1, 2020, the contents of which are hereby incorporated by reference in their entirety.

### BACKGROUND

Extinguishing combustion reactions is a significant challenge in controlled environments, such as low-gravity, high purity, or chemically sensitive environments. Technology available for such specialized applications typically uses a carbon dioxide-based powder that coats a surface and starves the reaction of oxygen. Carbon dioxide-based powder or other chemical fire-retardants may contaminate sensitive equipment, may pose a risk to humans, and may necessitate clean-down procedures that reduce the efficiency of processes.

In some environments, where combustion occurs under diffusion limited or species-limited conditions, reactions may generate heat that is nearly invisible, for example, by radiating energy in the infrared spectrum, rather than the visible spectrum. Such conditions may be found in microgravity environments, controlled or inert atmosphere environments as in clean rooms, or where the combustion otherwise does not generate a visible flame.

For at least these reasons, there is a need to improve systems and devices for detecting and intervening to extinguish combustion reactions in cleanroom environments such as those found in pharmaceutical, food, semiconductors, and other high-tech industries where the release of chemical compounds could result in costly contamination or toxification. Similarly, microgravity environments, such as those found in orbital systems or space vehicles, low gravity environments such as those found on planetary or moon base stations, as well deep-sea environments, where deployment of chemical retardants brings significant risk of contamination, would benefit from such improvements.

### SUMMARY

This summary is provided to introduce a selection of concepts in a simplified form that are further described below in the detailed description. This summary is not intended to identify key features of the claimed subject matter, nor is it intended to be used as an aid in determining the scope of the claimed subject matter.

Devices, systems, and methods for extinguishing fires are provided. A device for extinguishing fires may include a nozzle defining a flow channel. The device may include a convector fluidly coupled with the flow channel and configured to introduce a flow through the flow channel. The device may also include a vortex generator disposed within the nozzle, the vortex generator positioned to interact with the flow and to form a stream-wise vortex external to the nozzle.

In some embodiments, the vortex generator includes a vane characterized by a long axis. The flow may be characterized by a flow direction. The long axis may be angled relative to the flow direction by a nonzero angle of attack. The nozzle may be characterized by a longitudinal axis parallel to the flow direction. The vortex generator may include a plurality of vanes. Each vane of the plurality of vanes may be disposed within the nozzle at a position on the longitudinal axis. Each vane may be angled relative to the flow direction by a respective angle of attack. The plurality of vanes may include a first vane, a second vane, and a third vane, each having a height “H” where H is a number. The first vane and the second vane may be separated by a first distance, measured along an internal surface of the nozzle at the position, the first distance being defined by a first dimensionless ratio of the first distance and H from 0.01 to 1.00. The second vane and the third vane may be separated by a second distance, measured along the internal surface of the nozzle at the position, the first distance being defined by a first dimensionless ratio of the first distance and H from 0.50 to 1.50.

The vortex generator may be a first vortex generator. The device may also include a second vortex generator disposed within the nozzle, downstream from the first vortex generator relative to the flow direction. The first vortex generator may include a first vane of a first size. The second vortex generator may include a second vane of a second size. The first size may be larger than the second size. The first size may be smaller than the second size. The stream-wise vortex may include three constituent vortices. A first constituent vortex of the three constituent vortices may rotate in a first direction. A second constituent vortex and a third constituent vortex of the three constituent vortices may rotate in a second direction. The second direction may oppose the first direction.

A system for extinguishing fires may include the device above of various embodiments, positioned proximal to a region of interest. The system may include a sensor directed toward the region of interest. The system may include a control module in electronic communication with the device. The system may include one or more processors in electronic communication with the sensor and the control module. The system may also include a non-transitory computer-readable medium storing instructions that, when executed by the one or more processors, cause the one or more processors to perform operations. The operations may include detecting a combustion reaction in the region of interest using the sensor. The operations may include directing a stream-wise vortex from the device toward the combustion reaction using the control module. The operations may also include inducing forced advection at a surface undergoing the combustion reaction, such that the combustion reaction is characterized by a Damköhler number less than 10.

In some embodiments, the vortex generator may include a dielectric barrier discharge source. The device may be a first device. The system may further include a second device in electronic communication with the one or more processors via the control module. The second device may include a second nozzle, disposed in a second position relative to the region of interest. The second device may include a second vortex generator, disposed within the second nozzle, the second vortex generator positioned to interact with a second flow and to form a second stream-wise vortex external to the second nozzle. Directing the stream-wise vortex toward the combustion reaction using the control module may include selecting the first device or the second device and activating a convector of the selected device to generate the flow.

A method of extinguishing a fire may include generating a flow characterized by a stream-wise vortex. The method may include directing the flow toward a material undergoing a combustion reaction. The method may also include inducing forced advection at the material, such that the combustion reaction is characterized by a Damköhler number less than 10. The method may be implemented using the systems and/or the devices described above.

In some embodiments, generating the flow includes drawing a gas from the ambient environment or from a compressed gas source and flowing the gas through a flow straightener. The ambient environment may be a microgravity environment. The flow may be an air flow. The method may further include detecting the combustion reaction in a region of interest using a sensor. Generating the flow may include introducing the flow to a nozzle and interacting the flow with a vortex generator disposed within the nozzle, the vortex generator positioned to form the stream-wise vortex external to the nozzle.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram illustrating an example system including vortex devices, sensors, logic, and control circuitry, in accordance with various embodiments.

FIG. 2A is a schematic diagram illustrating an example vortex device, in accordance with various embodiments.

FIG. 2B is a schematic diagram illustrating another example vortex device, in accordance with various embodiments.

FIG. 2C is a schematic diagram illustrating another example vortex device including a compressed gas source, in accordance with various embodiments.

FIG. 3 is a schematic diagram illustrating an example internal surface of a vortex device including vortex generators for forming a stream-wise vortex disposed in a serial configuration along the flow direction, in accordance with various embodiments.

FIG. 4 is a schematic diagram illustrating an example vortex device for generating a vortex whip, using a parallel vortex generation configuration with respect to the flow direction, in accordance with various embodiments.

FIG. 5 is a schematic diagram illustrating an example arrangement of vortex generators for forming a vortex whip, in accordance with various embodiments.

FIG. 6 is a schematic diagram illustrating an example internal surface of a vortex device including vortex generators for forming a vortex whip, in accordance with various embodiments.

FIG. 7 is a schematic diagram illustrating an example configuration for vortex generators, in accordance with various embodiments.

FIG. 8 is a schematic diagram illustrating an example alternative technology for vortex generators, in accordance with various embodiments.

FIG. 9 is a flowchart that illustrates an example method for extinguishing a fire, in accordance with various embodiments.

FIG. 10 is a block diagram that illustrates aspects of an example computing device, in accordance with various embodiments.

In the above-referenced drawings, like reference numerals refer to like parts throughout the various views unless otherwise specified. Not all instances of an element are necessarily labeled to simplify the drawings where appropriate. The drawings are not necessarily to scale, emphasis instead being placed upon illustrating the principles being described.

### DETAILED DESCRIPTION

Devices, systems, and methods are described for extinguishing combustion reactions using stream-wise vortex generators, including vortex whip generators. Forced advection near a surface undergoing a combustion reaction can reduce or inhibit the propensity of the combustion reaction to self-sustain. In this way, a fluid flow that includes chemicals that would otherwise act as either fuel or oxidizer can extinguish the reaction. Rather than rely on chemical or bulk thermal means, embodiments described herein may direct a stream-wise vortex toward surfaces undergoing a combustion reaction, using ambient air or a compressed gas source as the fluid.

Embodiments include, but are not limited to, individual handheld devices, mounted devices coupled to sensors and control circuitry, and multi-device systems, actively controlled to detect and extinguish combustion reactions using advection near a surface undergoing a combustion reaction. While description focuses on several illustrative examples, these examples are intended to be non-limiting. It is understood that the devices, systems, and methods described herein could be deployed in general environments for extinguishing combustion reactions, but also in other contexts where a chemical reaction is exothermic and self-sustaining, such that parameters of the chemical reaction can be controlled through advection near the surface.

Combustion generally describes reactions where a fuel and an oxidizer react to evolve an oxide, water vapor, and heat. In the context of carbonaceous materials, the fuel is a carbon source, the oxidizer is oxygen, and the oxide is carbon monoxide or carbon dioxide. Many types of combustion reactions are known, including those for which the fuel is not carbon-based and/or the oxidizer not oxygen, such that the reaction evolves a different oxide and/or does not evolve water vapor. In the general case, however, combustion reactions are net-exothermic and exhibit a positive correlation between temperature and reaction rate. In this way, a combustion reaction tends to be self-sustaining under typical conditions while fuel and oxygen are available.

Approaches to extinguishing combustion reactions tend to focus on starving the reaction of oxygen. Examples of such approaches include sealing the environment to allow the reaction to consume available oxygen, coating reacting surfaces with chemical retardants that either scavenge oxygen or act as a barrier between the fuel and the atmosphere, or displacing the oxygen in the environment with an inert gas (e.g., carbon dioxide, nitrogen, etc.). In some conditions, however, these approaches are unavailable or ineffective, for example, where the fuel includes an oxidizer, as may occur in combustion of some minerals or chemical propellants, where the environment cannot be sealed, flushed, or is otherwise sensitive to contamination by chemical fire retardants. Examples of such environments include, but are not limited to, cleanroom environments, such as those found in pharmaceutical manufacturing, food processing, semiconductor processing, and other high-tech industries where the release of chemical compounds could result in costly contamination or toxification. Similarly, microgravity environments, such as those found in orbital systems or space vehicles, low gravity environments such as those found on planetary, asteroid, or moon base stations, as well deep-sea environments, where deployment of chemical retardants brings significant risk of contamination, preclude the use of typical approaches.

In some situations, a combustion reaction occurs in the gas phase near a surface of the fuel, rather than in the liquid or solid phase fuel itself. For example, in terrestrial applications, fuels like volatile organic chemicals, as are evolved when paraffins, alkanes, or polymers are exposed to elevated temperatures, concentrate near a surface and act as a fuel-rich zone that can sustain a combustion reaction. The heat of the combustion reaction, in turn, volatilizes more fuel for the reaction from the surface, such that the reaction becomes self-sustaining and can spread. In contrast, by dispersing the fuel from the zone near the surface, the heat flux near the surface can be reduced, which in turn reduces the rate of evolution of volatile fuel. Instead of spreading, the combustion reaction can diminish until it is extinguished.

Dispersal of volatile fuel by forced convection may be improved when the boundary layer near the fuel source material is compressed. To that end, a stream-wise vortex, including vortex whip configurations, may be applied to extinguish combustion reactions by mechanical convection, rather than by application of chemical fire retardants. The term “stream-wise vortex” in this context refers to an azimuthally rotating vortex, centered about an axis of rotation that is aligned with a direction of flow (referred to as “the flow direction”). In some embodiments, a device includes a convector, a nozzle, and one or more vortex generators arranged on an internal surface of the nozzle. The combined effect of the vortex generators is to induce stream-wise vorticity in a flow exiting the nozzle, which may include one or more constituent stream-wise vortices rotating clockwise and/or counter-clockwise relative to the flow direction. Such an arrangement, with a fluid flowing near a surface, including one or more parallel azimuthal vortices, can be used to compress the velocity and/or thermal boundary layer near a surface or region undergoing a combustion reaction. This, in turn, increases the extent of convection near the surface, inhibits the tendency of the combustion reaction to self-sustain, and can even quench the reaction, due to the rapid mixing in comparison to the chemical ignition delay time.

Without being bound to a single physical mechanism or phenomenon, the influence of increasing forced convection with stream-wise vorticity may be achieved when the reaction system can be described by a Damköhler number on the order of one (e.g., a value less than ten). Multiple Damköhler numbers are defined for different chemical reaction environments. In general, Damköhler numbers relate the chemical reaction timescale (reaction rate) to the transport phenomena timescale occurring in a system. In the case of forced convection near a surface undergoing a combustion reaction, the Damköhler number for continuous or semi-batch chemical processes without interphase mass transport may be used, defined as the dimensionless ratio of the chemical reaction rate to the convective mass transport rate. In mathematical terms, the relevant Damköhler number may be defined as

$$D = \frac{reaction rate}{convective mass transport rate} = k {C}_{o}^{n - {1}_{𝒯}}$$

where k is the kinetic reaction rate constant, C₀ is the initial concentration of reactant, n is the reaction order, and tau (“τ”) is the mean residence time. In general, as the Damköhler number increases, the degree of conversion of reactant into product increases, reflecting the increasing importance of the reaction rate term. For example, for a first order reaction (n=1), the equilibrium conversion may be estimated at approximately 10% or less for a Damköhler number less than 0.1. By contrast, for the same reaction, a Damköhler number on the order of 10 produces a conversion of approximately 90% or greater. In this way, by influencing the convective mass transport rate near a surface undergoing a combustion reaction, the conversion fraction may be reduced below a threshold at which the reaction ceases to be self-sustaining.

In light of the dependency of the Damköhler number on reaction order, and the complex kinetics of combustion reactions, the evaluation of the Damköhler number may be challenging under test conditions. As such, devices, systems, and methods described herein may measure and/or control parameters that are directly measurable, without estimating the Damköhler number itself. For example, rather than estimating the reaction rate or the convective mass transport rate directly, systems may be calibrated at the time of manufacture or assembly using a standardized reaction system that is fully-defined. In this way, the velocity of a flow through a nozzle of a device may be correlated to a temperature measured from a combustion reaction by optical techniques including, but not limited to infrared thermometry. Similarly, rather than simulating the local conditions at the surface of the material, a vortex device may be calibrated to increase or decrease a fluid flow rate through the device based on the temperature measurement directly, rather than estimating the flowrate based on a calculation of the Damköhler number. It is understood that, in the forthcoming description, where reference is made to Damköhler numbers and conditions giving rise to Damköhler numbers of a given value, a device that generates a stream-wise vortex and directs it toward a reacting material may be controlled without directly calculating the Damköhler number in real time.

Multiple approaches may be taken to generating stream-wise vortices. A vortex generator (“VG”) may be or include, but is not limited to, vanes positioned in the path of flow, plasma actuators, pneumatic jets, piezo-electric actuators, or other types of electromagnetic or mechanical vortex generators with different topology. While the forthcoming description focuses on the application of vanes at one or more positions on the internal surface of a nozzle, this is intended for simplicity and clarity of explanation, rather than as a limiting or preferred embodiment. In this way, the approach to generating the stream-wise vortices may include one or more of the techniques listed above.

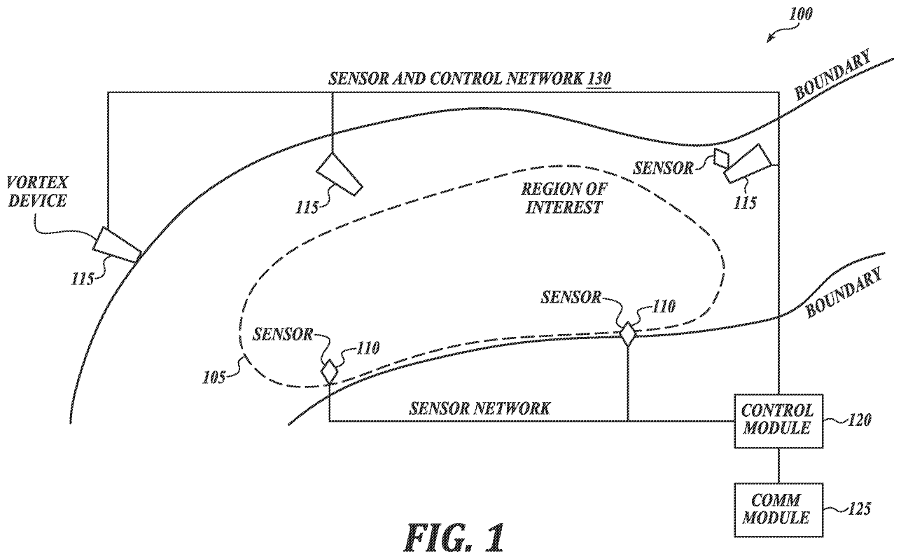

FIG. 1 is a schematic diagram illustrating an example system 100 including vortex devices, sensors, and control circuitry, in accordance with various embodiments. The illustrated example system 100 is addressed at detecting and extinguishing a combustion reaction within a general region of interest 105. The region of interest 105, and the example system 100, may be defined for environments including, but not limited to, interior spaces, exterior spaces, terrestrial gravity, reduced gravity, microgravity, lunar gravity, increased gravity, in environments with ambient atmosphere or without ambient atmosphere, underwater, or in clean environments. The example system 100 includes one or more sensors 110, one or more vortex devices 115, one or more control modules 120, one or more communication modules 125, and a sensor and control network 130 linking the various components of the example system 100.

As illustrated, the region of interest 105 defines a space within which a combustion reaction may occur, and may be delineated by one or more boundaries of a physical space. For example, the boundaries may be or include physical surfaces, such as tables, walls, or other surfaces. Additionally or alternatively, the region of interest 105 may be defined to include objects, such as a machine, electronic system, or other device and/or object. For example, the region of interest 105 may include a workstation in a clean room facility that is incompatible with dry-chemical fire retardants and cannot be vented. The workstation may be or include a table or a specialized system including tools for fabricating or processing objects. In this way, the region of interest 105 may be defined by arrangement of the sensors 110 and the vortex devices 115 at one or more positions around the region of interest 105, such that a combustion reaction may be readily detected and a stream-wise vortex, such as a vortex whip, may be generated and directed toward the site of the reaction in the region of interest 105. In this way, forced advection may be induced at the surface undergoing the combustion reaction, which may reduce the conversion of the combustion reaction and disperse volatile fuel near the surface, in line with the Damköhler number being about 10 or less, about 9 or less, about 8 or less, about 7 or less, about 6 or less, about 5 or less, about 4 or less, about 3 or less, about 2 or less, about 1 or less, about 0.9 or less, about 0.8 or less, about 0.7 or less, about 0.6 or less, about 0.5 or less, about 0.4 or less, about 0.3 or less, about 0.2 or less, about 0.1 or less, including fractions or interpolations thereof. As described above, reaction conversion decreases with decreasing value of the Damköhler number.

While description focuses on a single region of interest 105 for clarity of explanation, the example system 100 may be configured to monitor multiple regions of interest including the region of interest 105. For example, a clean room environment, an orbiting installation, or a compartmentalized space may include multiple potential fuel sources in separate physical locations. In such cases, the sensor and control network 130 may be configured to include sensors 110 and vortex devices 115 addressed at different regions of interest 105. For example, an environment including multiple workstations may include a corresponding number of regions of interest 105, such that the sensor and control network 130 may include at least one sensor 110 and at least one vortex device 115 addressed at each workstation. In some embodiments, a sensor 110 or a vortex device 115 is configured to cover more than one region of interest 105, for example, where the sensor 110 or the vortex device 115 is mounted on a motor stage or otherwise can observe or intervene in either region of interest 105 equally.

Advantageously, providing multiple sensors 110 as part of the example system 100 may permit the location of a combustion reaction to be triangulated with improved precision relative to a configuration using a single sensor 105. Similarly, including multiple vortex devices 115 may permit the example system 100 to select the vortex device 115 nearest the location of the combustion reaction or the vortex device 115 best able to direct a stream-wise vortex toward the combusting surface (e.g., a path that is substantially free of obstructions). Similarly, where multiple combustion reactions are detected, multiple stream-wise vortices may be directed at different locations by coordinating the vortex devices 115.

The components of the example system 100 may be implemented as an automatic (e.g., operating without human intervention) fire/combustion detection and intervention system. In some embodiments, the sensors 110 are arrayed to observe the region of interest 105, and the vortex devices 115 are positioned such that the objects and/or surfaces within the region of interest 105 can be exposed to stream-wise vortices from at least one direction. Each vortex device 115 may be activated and controlled by the control module 120. The control module 120 may be or include a computer system configured with control circuitry, such as processors, memory, or digital/analog input-output components to facilitate electronic communication between the control module 120 and the sensors 110 or vortex devices 115. In some embodiments, the control module 120 is operably coupled with the sensors 110 and/or the vortex devices 115 via the communication module 125, which may be or include available wireless technologies that are compatible with the region of interest 105. For example, wireless technologies such as radio transmission (e.g., cellular communications, Wi-Fi, Bluetooth) or optical transmission (e.g., infrared transmission, laser-pulse communication, etc.) may be implemented in place of or in addition to wired communication between the electronic components of the example system 100.

Additionally or alternatively, the communication module 125 may also provide electronic communication between the control module 120 and systems external to the sensor and control network 130. For example, the control module 120 may be operably coupled to a server or other computer device, for example over a network, such that the control module 120 may send and/or receive data from the external system. In some embodiments, a central emergency management system may communicate with the control module 120 via the communication module 125 and in this way may facilitate coordinated response to multi-point emergencies, may engage responder resources, or may activate other systems. For example, the control module 120 may serve as a relay that receives commands from the central emergency management system, such that computational processes involved in detecting a combustion reaction and coordinating a response are handled by the central system. Similarly, the sensor and control network 130 may be configured to collect data, that may be sent to a data store, such as a centralized data store or a distributed storage system.

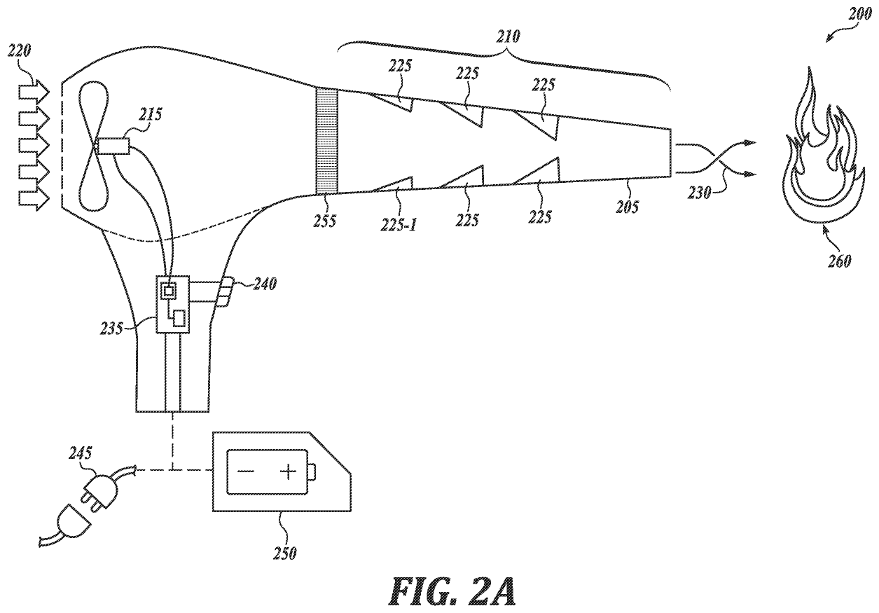

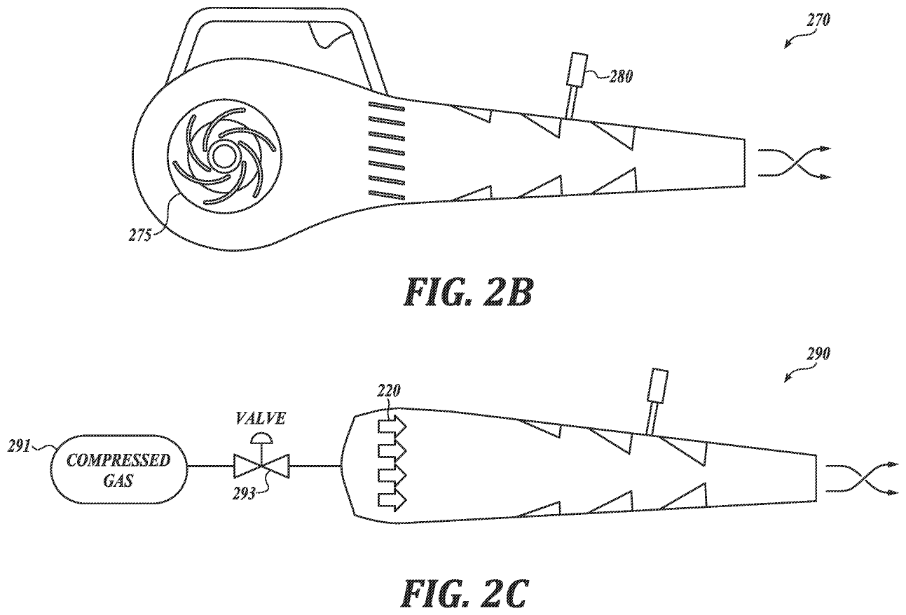

FIG. 2A is a schematic diagram illustrating an example vortex device 200, in accordance with various embodiments. The example vortex device 200 may be an example of the vortex devices 115 of FIG. 1 implemented as part of the example system 100 of FIG. 1. As illustrated, the example vortex device 200 includes a nozzle 205 defining a flow channel 210, a convector 215 fluidly coupled with the flow channel 210 and configured to introduce a flow 220 through the flow channel 210, and one or more vortex generators 225 disposed within the nozzle 205, the vortex generator(s) 225 positioned to interact with the flow 220 and to form a stream-wise vortex 230 external to the nozzle 205. In some embodiments, the example vortex device 200 incorporates control circuitry 235, manual control(s) 240, and power sources including, but not limited to, line-power 245 and/or a battery 250. In some embodiments, a flow straightener is disposed between the flow channel 210 and the convector 215.

Following the flow 220 through the example vortex device 200, the convector 215 draws in fluid from the environment around the example vortex device 200. The fluid may be or include ambient gas, such as air or a composed gas provided in a controlled environment, such as an orbiting or submarine installation. The configuration of the convector 215 may depend on the density of the fluid, and may be or include, but is not limited to, an impeller, a bellows, a centrifugal blower, an ionizing electrostatic accelerator, or the like. Alternative embodiments are described in reference to FIGS. 2B-2C, below. Downstream from the convector 215, relative to the direction of the flow 220 from the convector 215 to the flow channel, the flow 220 may be modified by the flow straightener 255. The flow straightener 255 may be a screen or filter through which an array of conduits are formed of varying size and internal geometry. The conduits may be positioned in the flow straightener 255 to deflect and/or redirect portions of the flow 220, such that the flow 220 exhibits a substantially uniform flow front at the entrance to the flow channel 210, prior to encountering a first vortex generator 225-1 of the vortex generator(s) 225. In this context, “substantially” is used to describe a deviation of 10% or less from uniformity.

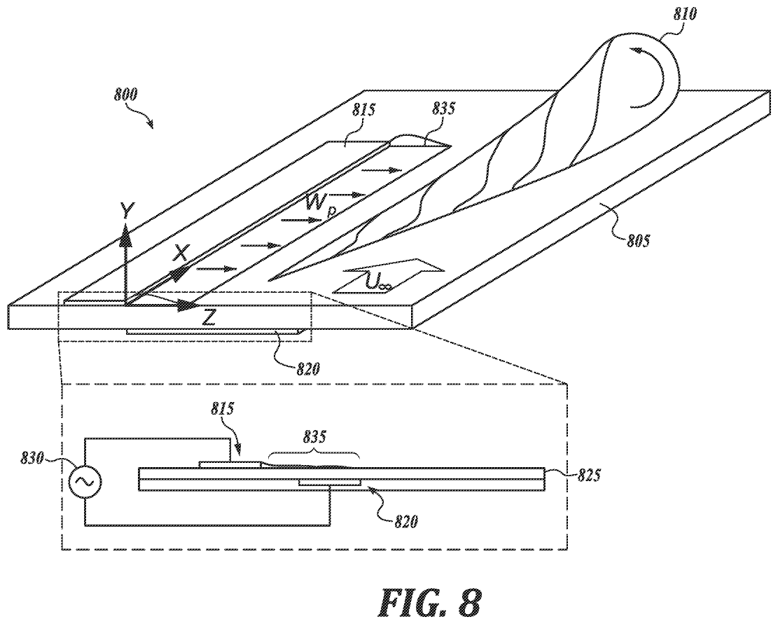

The vortex generators 225 may be or include vane-type, pneumatic jet-type, plasma actuator-type, piezo-electric type, wedge-type, ramp-type, or other electrical or mechanical configurations. The example vortex device 200 is illustrated with vane-type vortex generators 225, but the other types are contemplated, as described in more detail in reference to FIG. 8.

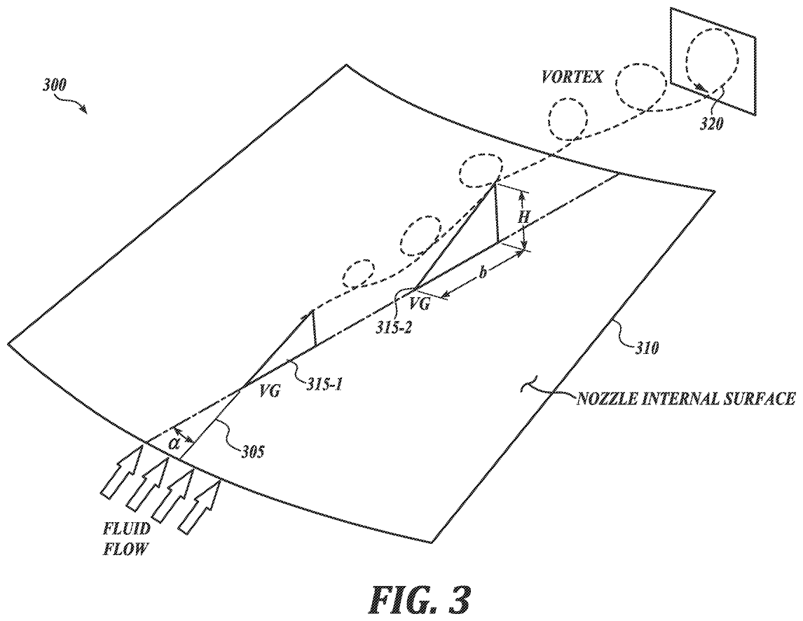

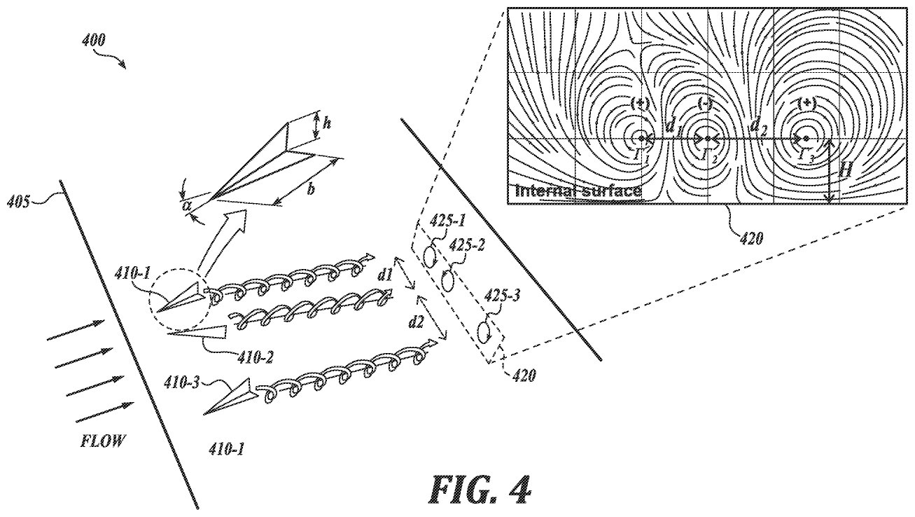

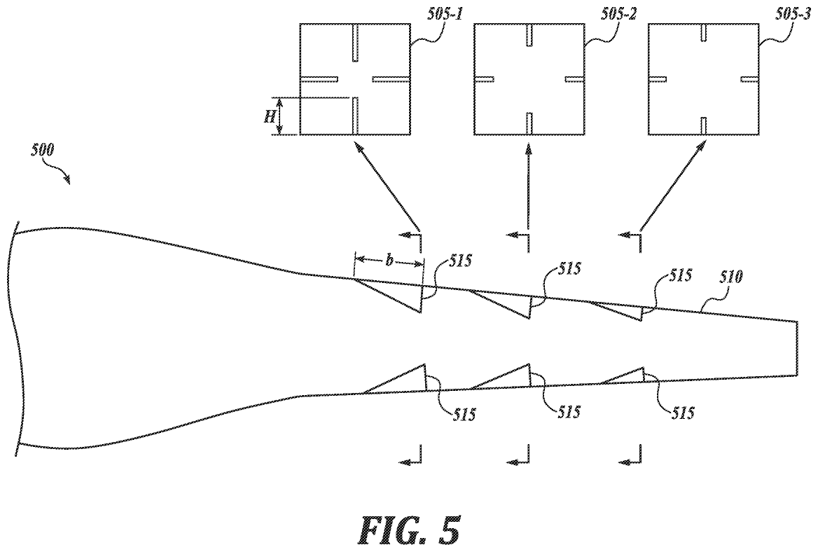

The example vortex device 200 is illustrated with three vortex generators 225, although the number and position of the vortex generators 225 may depend on the intended application of the example vortex device 200. For example, the vortex generators 225 may number more or fewer, depending on the complexity of the stream-wise vortex 230 to be generated, as described in more detail in reference to FIGS. 3-4. For example, the example vortex device 200 may include one vortex generator 225, two vortex generators 225, three vortex generators 225, four vortex generators 225, or more. As part of operating the example vortex device 200, the stream-wise vortex 230 may be directed toward a surface undergoing a combustion reaction 260.

While the combustion reaction 260 is illustrated as a recognizable visible flame, it is understood that devices, systems, and methods contemplated herein are not limited to such flames. The combustion reaction 260 may be or include alternative forms, such as effectively-invisible flames that emit a fraction of energy in the visible and/or ultraviolet spectral ranges, invisible flames that emit a large fraction of energy in the invisible infrared or ultraviolet spectral ranges, or the like. In this way, sensor systems (e.g., sensors 110 of FIG. 1) may be configured to measure radiation in UV, visible, and/or IR spectral ranges, may be calibrated for a specific or otherwise foreseeable combustion reaction 260, and may actuate the example vortex device 200 to direct the stream-wise vortex 230 toward the combustion reaction 260.

In handheld and manually controlled configurations, the example vortex device 200 may be manually directed toward (e.g., aimed toward) the combustion reaction 260. In such cases, the example vortex device 200 may include a display and a sensor system to convert invisible radiation from the combustion reaction 260 into visible spectrum wavelengths, as is done in IR or UV hyperspectral imagers. Additionally and/or alternatively, the nozzle 205 may be manually aimed at the combustion reaction 260 in cases where a visible flame is produced

The flow channel 210 may have different cross section shapes such as circular, oblong, ellipsoid, square, and rectangular among others. The cross section can be selected according to size or volume of operational areas/regions, required mass flow, required flow speed, geometrical constraints of the working spaces or potential fire hazard areas, and available space to mount and operate the system 100 among other considerations.

FIG. 2B is a schematic diagram illustrating another example vortex device 270, in accordance with various embodiments. As illustrated, example vortex device 270 is another example of a configuration that may be applied in manual control and/or in automated systems, and may be an example of the vortex device(s) 115 of FIG. 1. The example vortex device 270 also includes vortex generators disposed in a flow channel of a nozzle, and includes a flow straightener. Power sources and control circuitry are not shown for simplicity, but it is understood that the example vortex device 270 also includes such components.

As shown, the example vortex device 270 includes a convector 275 that is differently configured than the convector 215 of FIG. 2A. The convector 275 is illustrated as a centrifugal blower, as opposed to an impeller, but it also may be otherwise configured, for example, as an axial blower. The example vortex device 270 also incorporates a sensor 280, which may be an example of the sensor(s) 110 of FIG. 1. The sensor 280 may be or include a hyperspectral imaging sensor, a thermal sensor, and/or a spectrometer, such that the example vortex device 270 may be implemented as part of a sensor and control network (e.g., sensor and control network 130 of FIG. 1). As described in reference to FIG. 2A, the sensor 280 may also include or be electronically coupled with a display, such that the example vortex device 270 provides information useful to a human user to indicate the direction, intensity, or other information relevant to detecting a combustion reaction and extinguishing it using a stream-wise vortex.

FIG. 2C is a schematic diagram illustrating another example vortex device 290, in accordance with various embodiments. The example vortex device 290 may be an example of the vortex device(s) 115 of FIG. 1, and also includes sensor(s), vortex generators disposed in a flow channel of a nozzle. In contrast to the example vortex devices of FIGS. 2A-2B, however, the example vortex device 290, in addition to or in alternative to a mechanical convector (e.g., convector 215 of FIG. 2A, convector 275 of FIG. 2B), is configured to generate the flow 220 by controlled release of a compressed gas from a compressed gas source 291, via a valve 293 (e.g., a metering valve, control valve, etc). The valve may be controlled as part of an automated system (e.g., sensor and control network 130 of FIG. 1) and/or may be manually actuated using a manual control (e.g., manual control 240 of FIG. 2A).

FIG. 3 is a schematic diagram illustrating an internal surface of an example vortex device 300 including vortex generators for forming a stream-wise vortex, in accordance with various embodiments. The example vortex device 300 may be an example of vortex device(s) 115 of FIG. 1 and/or vortex device 200 of FIG. 2A. The internal surface is illustrated as a section, defined relative to a longitudinal axis 305 of a nozzle 310, which may be an example of nozzle 205 of FIG. 2A, and may illustrate a portion of the flow channel 210 of FIG. 2A. The longitudinal axis 305 may be substantially aligned with the flow direction of a fluid flow, which may be an example of the flow 220 of FIG. 2A. One or more vortex generators (“VG”) are shown being disposed on the internal surface, positioned to interact with the fluid flow to generate a stream-wise vortex 320, which may be an example of the vortex 230 of FIG. 2A. In this context, “substantially” is used to describe a deviation of 10% or less from alignment.

As illustrated, the stream-wise vortex 320 is characterized by azimuthal rotation around a streamline. Shown in cross-section roughly normal to the flow direction as a schematic, the vortex 320 exhibits counter-clockwise rotation relative to the flow direction. The rotation direction (e.g., clockwise vs counter-clockwise), also referred to as the sense of rotation, may be defined passively and/or controlled actively, as where the vortex generator 315 is fixed in the flow channel, or may be actuated or incrementally controlled.

In the example vortex device 300, the vortex generators 315 are or include vanes characterized by a long axis “b” (also referred to as the “chord”) and a height “H,” the long axis b is angled relative to the flow direction by a nonzero angle of attack, “α.” The angle of attack α may be defined relative to the longitudinal axis 305, as the longitudinal axis 305 is substantially aligned with the flow direction. Within a parametric window of values of b, H, and α, the size, shape, and orientation of the vane may determine properties of the vortex 320. For example, increasing one or more of the parameter values may increase the rotational velocity, size, or distance of the vortex relative to the surface. Outside the parametric window, by contrast, the flow may transition to unstable or turbulent flow, without forming a stream-wise vortex, or may form a stream-wise vortex that detaches from the surface of the nozzle 310.

Generally, vortex strength, denoted by gamma “F,” increases with the magnitude of the angle of attack, where the direction of rotation (also referred to as the “sense of rotation,” or SoR) depends on the sign of a relative to the longitudinal axis 305. For example, where the flow direction is defined as the reference axis for α, α is defined as positive where the vane is angled to deflect fluid flow to the right, relative to the flow direction. Similarly, α is defined as negative where the vane is angled to deflect fluid flow to the left, relative to the flow direction. In general, for vane-type vortex generators, the sign of α is indicative of the sense of rotation, with positive α indicating counter-clockwise rotation (negative SoR) and negative α indicating clockwise rotation (positive SoR).

In some embodiments, values of a are in a range from 0.1° to 50.0°, from 0.1° to 45.0°, from 0.1° to 40.0°, from 0.1° to 35.0°, from 0.1° to 34.0°, from 0.1° to 33.0°, from 0.1° to 32.0°, from 0.1° to 31.0°, from 0.1° to 30.0°, from 0.1° to 29.0°, from 0.1° to 28.0° from 0.1° to 27.0°, from 0.1.0° to 26.0°, from 0.1° to 25.0°, from 0.1° to 24.0°, from 0.1° to 23.0°, from 0.1° to 22.0°, from 0.1° to 21.0°, from 0.1° to 20.0°, from 0.1° to 19.0°, from 0.1° to 18.0°, from 0.1° to 17.0°, from 0.1° to 16.0°, from 0.1° to 15.0°, from 0.1° to 14.0°, from 0.1° to 13.0°, from 0.1° to 12.0°, from 0.1° to 11.0°, from 0.1° to 10.0°, from 0.1° to 9.0°, from 0.1° to 8.0°, from 0.1° to 7.0°, from 0.1° to 6.0°, from 0.1° to 5.0°,from 0.1° to 4.0°, from 0.1° to 3.0°, from 0.1° to 2.0°, from 0.1° to 1.0°, from 0.1° to 0.9°, from 0.1° to 0.8°, from 0.1° to 0.7°, from 0.1° to 0.6°, from 0.1° to 0.5°, from 0.1° to 0.4°, from 0.1° to 0.3°, from 0.1° to 0.2°, or fractions or interpolations thereof.

It is understood that stream-wise vorticity is governed by momentum transfer near the internal surface of the nozzle 310. As such, the strength and stability of the vortex 320 may depend on the combination of parameters b, H, a, and the fluid flow velocity “U_{∞}” such that the vortex 320 with characteristics that serve to suppress combustion reactions may form within a relatively narrow parameter space. While each parameter may have an influence on vortex formation and strength, the parameters are understood to be coupled, with a change in one parameter affecting the influence of the other parameters on the vortex 320. In this way, constituent elements of the vortex generators 315 may be defined using nondimensional parameters as an approach to accounting for the influence of other coupled parameters, as described in more detail in reference to FIG. 4.

In some embodiments, the geometry of the vortex generators 315 differ from the vortex spacings, at least in part due to the fact that a vortex may be generated at a nonzero distance from the trailing edges of the vortex generators 315, but rather may be generated at a distance from the trailing edge on the suction side. Where the vortex circulation, or strength, may be substantially proportional to the planform area of the vortex generators 315 and its angle of attack. The former may be proportional to the product of B and H. In this way, the vortex circulation is approximately proportional to the product of B with H and α. As described in reference to the forthcoming figures, the vortex generators 315 may include multiple vanes in a serial configuration, wherein each of the vanes making up a respective vortex generator 315 is disposed within the nozzle at different positions on the longitudinal axis (i.e. serial configuration), and wherein each vane is angled relative to the flow direction by a respective angle of attack. In some embodiments, the size of the vanes may increase with increasing distance from the inlet to the flow channel, such that a first vortex generator 315-1 of the vortex generators 315 may include vanes that are smaller than vanes included in a second vortex generator 315-2 of the vortex generators 315. In some embodiments, the size of the vanes may decrease with increasing distance from the inlet to the flow channel, such that the first vortex generator 315-1 of the vortex generators 315 may include vanes that are larger than vanes included in the second vortex generator 315-2 of the vortex generators 315.

When vortex generators are arranged in a serial configuration, the resulting stream-wise vortex whip is produced by the successive interactions between the vortex and vortex generators downstream. The vortex generated by the first VG 315-1 interacts with a second VG 315-2 positioned in such a way that it amplifies the vortex intensity. More than two VGs can be disposed along the nozzle.

The individual vanes making up each vortex generator 315, in embodiments including multiple vanes, may be angled differently relative to the flow direction. Alternatively, the vanes may be angled uniformly relative to the flow direction/longitudinal axis 305. In this way, a vortex generator 315 may generate multiple vortices 320 that may share the same sense of rotation, different senses of rotation, different strengths, uniform strengths, or any combination thereof. Advantageously, interaction between the vortices may result in the formation of a vortex whip, as described in reference to FIG. 4, below.

FIG. 4 is a schematic diagram illustrating an example vortex device 400 including vortex generators for forming a vortex whip, in accordance with various embodiments. The example vortex device 400 is illustrated as a section of a nozzle 405 including an internal surface, which may be an example of vortex device 115 of FIG. 1, vortex device 200 of FIG. 2A, or vortex device 300 of FIG. 3. The internal surface of the nozzle 405 includes multiple vortex-generating vanes 410, including a first vane 410-1, a second vane 410-2, and a third vane 410-3, configured with a size, shape, and orientation to generate a vortex whip 420 including a corresponding number of constituent stream-wise vortices 425 making up. In some embodiments, the vortex generator vanes 410 are disposed at the same position on the nozzle longitudinal axis (i.e. parallel configuration). The vortex whip 420 may be an example of the stream-wise vortex 230 of FIG. 2A, where the overall impact of directing the vortex whip 420 toward a combustion reaction may result from interactions between the constituent vortices 425.

The vortex whip 420 includes a first constituent vortex 425-1, a second constituent vortex 425-2, and a third constituent vortex 425-3, respectively generated by the corresponding vanes 410. Each of the constituent vortices 425 is initially formed by one of the vanes 410 as described in reference to the vortex generator(s) of FIG. 3, where each of the vanes 410 is described by a respective set of parametric values of b, H, and a, and where the flow is described by a value U_{∞} that may be substantially uniform across a lateral flow front such that each of the vanes 410 contacts the flow under similar conditions. The vanes 410 may be angled to form constituent vortices 425 with positive or negative senses of rotation. As illustrated in FIG. 4, the first constituent vortex 425-1 and the third constituent vortex 425-3 are characterized by a positive sense of rotation (+), while the second constituent vortex 425-3 is characterized by a negative sense of rotation (−). For stable stream-wise vortices, including the vortex whip 420, the distance “d” between the axes of rotation 427 for the constituent vortices 425, corresponding to the center of rotation in the inset illustrating the vortex whip 420, is equivalent to the lateral distance between the vanes 410. For example, a first distance “d1” is defined as the lateral distance between the first vane 410-1 and the second vane 410-2. Similarly, a second distance “d2” is defined as the lateral distance between the second vane 410-2 and the third vane 410-3.

Each of the constituent vortices 425 are further characterized by a respective vortex strength “Γ” that depends on parameters of the vanes 410, such as α and/or the flow velocity U_{∞}. In some embodiments, the efficacy of the vortex whip 420 to extinguish combustion reactions depends on the flow field generated by the constituent vortices 425 at or near the internal surface of the nozzle 405. The flow field, in turn, is a product of the interactions between the constituent vortices 425 and depends in part on the respective strengths Γ₁, Γ₂, Γ₃, of the first constituent vortex 425-1, the second constituent vortex 425-1, and the first constituent vortex 425-3, as well as the respective inter-vortex distances d1 and d2. As illustrated in the cross-sectional inset of the vortex whip 420 in FIG. 4, the flow fields of the constituent vortices 425 interact to generate a local lateral flow that serves to compress the boundary layer at or near a surface undergoing a combustion reaction. As discussed in reference to the Damköhler number, compression of the surface boundary layer and introduction of lateral flow at or near the surface of a material undergoing a combustion reaction can disperse volatile fuel and/or reduce the temperature of the surface below a threshold at which the combustion reaction ceases to be self-sustaining, and can quench the reaction.

As with individual stream-wise vortices, as described in reference to FIG. 3, dimensionless numbers are defined to describe the configuration(s) of the vanes 410 that result in stable and/or improved vortex whip 420 generation. For example, a dimensionless variable relating the height H of each vane 410 the inter-vane distance d may be used as a parameter to define the spacing between the vanes. In terms of the vortex whip 420 and the constituent vortices 425, the distance of the axis of rotation 427 from the internal surface of the nozzle 405 may be considered as substantially equivalent to H within 5-10%.

The spacing d may influence the level of interaction between the constituent vortices 425. For example, when d/H<1, the constituent vortices 425 may interact more, while when d/H>1, the constituent vortices 425 may interact less. In the vortex whip 420, the three constituent vortices 425 interact to transfer energy from the third constituent vortex 425-3 to the second constituent vortex 425-2 and thence to the first constituent vortex 425-1. Interaction between the constituent vortices 425 may serve to increase the rotational velocity (e.g., reduce the period of rotation), such that the lateral velocity at or near the surface increases. In some cases, the vortex whip 420 is further improved by generating the constituent vortices 425 at a consistent height H such that the lateral flow generated at or near the surface is consistent, which may improve the stability of the vortex whip.

In this way, d1 and d2 may be the same or different, and dₓ/H may be about 5.0 or less, about 4.0 or less, about 3.0 or less, about 2.0 or less, about 1.9 or less, about 1.8 or less, about 1.7 or less, about 1.6 or less, about 1.5 or less, about 1.4 or less, about 1.3 or less, about 1.2 or less, about 1.1 or less, about 1.0 or less, about 0.9 or less, about 0.8 or less, about 0.7 or less, about 0.6 or less, about 0.5 or less, about 0.4 or less, about 0.3 or less, about 0.2 or less, about 0.1 or less, about 0.09 or less, about 0.08 or less, about 0.07 or less, about 0.06 or less, about 0.05 or less, about 0.04 or less, about 0.03 or less, about 0.02 or less, including fractions or interpolations thereof. For example, embodiments of the example vortex device 400 include configurations where d1/H is about 0.3, and d2/H is about 1.07.

In terms of vortex strength F, the example vortex device 400 may include vanes 410 described by a b, and H values such that the resulting respective values Γ₁<Γ₂<Γ₃. This relationship may improve the performance of the vortex whip 420 to introduce advection at or near a surface undergoing a combustion reaction. Without being bound to a single physical mechanism, the Biot-Savart law describes that the interaction and energy transfer between two vortices increases with vortex strength. In this way, forming constituent vortices 425 having progressively increasing vortex strengths permits a relatively stronger vortex to increase the velocity of a relatively weaker vortex and to compress it closer toward the surface. In this way, the ratio of strengths Γᵢ₊₁/Γᵢ is a meaningful dimensionless parameter for the example vortex device 400, in that it describes the influence of the relatively stronger of the constituent vortices 425 on the relatively weaker of the constituent vortices 425.

In some embodiments, the ratio of

$$\frac{{Γ}_{2}}{{Γ}_{1}} = \frac{{Γ}_{3}}{{Γ}_{2}} .$$

In some embodiments,

$$\frac{{Γ}_{2}}{{Γ}_{1}} \neq \frac{{Γ}_{3}}{{Γ}_{2}} .$$

In some embodiments,

$$\frac{{Γ}_{3}}{{Γ}_{2}} and \text{/} or \frac{{Γ}_{2}}{{Γ}_{1}}$$

is about 10.0 or less, about 9.0 or less, about 8.0 or less, about 7.0 or less, about 6.0 or less, about 5.0 or less, about 4.0 or less, about 3.0 or less, about 2.0 or less, about 1.0 or less, about 0.9 or less, about 0.8 or less, about 0.7 or less, about 0.6 or less, about 0.5 or less, about 0.4 or less, about 0.3 or less, about 0.2 or less. about 0.1 or less, or less, including fractions or interpolations thereof. For example,

$$\frac{{Γ}_{3}}{{Γ}_{2}} and \text{/} or \frac{{Γ}_{2}}{{Γ}_{1}}$$

may be equal to about 1.1, about 3.0, about 5.0, or other values. In some embodiments,

$$\frac{{Γ}_{3}}{{Γ}_{2}} and \text{/} or \frac{{Γ}_{2}}{{Γ}_{1}}$$

may be in a range from about 0.5 to about 5.0. While the vortex strength Γ may be challenging to measure in application conditions, the configuration of the vanes 410 and the flow velocity U_{∞} may be calibrated as part of fabrication of the example vortex device 400 such that the ratios are defined by a given value. In this context, “about” is used to indicate variation of up to 10% around the stated value.

FIG. 5 is a schematic diagram illustrating an example vortex device 500 including vortex generators for forming a vortex whip, in accordance with various embodiments. The example vortex device 500 may be an example of vortex device 115 of FIG. 1, vortex device 200 of FIG. 2A, vortex device 300 of FIG. 3, or vortex device 400 of FIG. 4. The example vortex device 500 includes three vortex generators 505 disposed at different positions on the internal surface of a nozzle 510. The internal surface of the nozzle 510 forms the shape of a quadrilateral, but it is understood that the nozzle 510 may define alternative cross-sections including, but not limited to, circular, elipsoid, polygonal, oblong, and slot shaped cross sections. The vortex generators 505 are vane-type and each include four similarly sized vanes 515 disposed substantially centered on each side of the nozzle 510. In this context, the term “substantially” is used to indicate a deviation from the stated position within +/−10%.

The example vortex generators 505 are differentiated by the size, shape, and/or orientation of the vanes 515. For example, a first vortex generator 505-1 of the vortex generators 505 may include vanes 515 that are characterized by higher values of H, b, and/or a, relative to a second vortex generator 505-2, and similarly with a third vortex generator 505-3. In some embodiments, the order is reversed, such that the first vortex generator 505-1 includes smaller vanes 515 than the second vortex generator 505-1, including smaller vanes 515 than the third vortex generator 505-1.

While the vanes 515 are illustrated having a consistent a-value, the angle of attack may be different between the vortex generators 505, as an approach to generating a vortex whip having constituent vortices of progressively increasing strength. For example, the first vortex generator 505-1 may be characterized by the largest α of about 30°, the second vortex generator 505-2 may be characterized by the next largest α of about 6°, and the third vortex generator 505-3 may be characterized by the smallest α of about 1.2°. The values stated here are meant as illustrative rather than limiting.

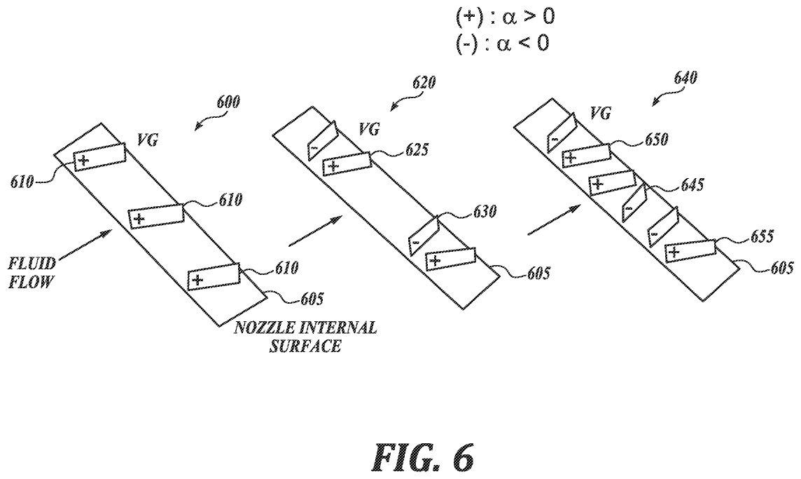

FIG. 6, is a schematic diagram illustrating example configurations for vortex generators, in accordance with various embodiments. Vortex generator 600, vortex generator 620, and vortex generator 640 may be included as part of a vortex device (e.g., vortex device 115 of FIG. 1, vortex device 200 of FIG. 2) individually or collectively. While the vortex generators are illustrated in FIG. 6 as separate, in some embodiments, vortex devices include each vortex generator at a different respective position on an internal surface of a nozzle 605. In this way, the combined effect of the vortex generators 600, 620, and 640, may generate a vortex whip when a fluid flow is introduced to the nozzle, as described in more detail in reference to FIGS. 1-4.

The vortex generator 600 is a vane-type vortex generator, including multiple vanes 610 of consistent b, H, and a values, and similar cross sectional shape. The resulting stream-wise vortex generated by the vortex generator 600 will generally include three constituent vortices of similar strength, sense of rotation, and height from the surface. As performance for application to combustion reactions improves with energy transfer from stronger to weaker vortices, it may be advantageous to include different vanes. To that end, the vortex generator 620 is a vane-type generator that includes positive-α vanes 625 and negative-a vanes 630. As described above, positive-a values induce a negative (−) sense of rotation in stream-wise vortices, while negative-a values induce a positive (+) sense of rotation in stream-wise vortices. When a fluid flow is introduced to the vortex generator 620, two vortex whips are generated downstream of the vanes 625 and 630. Each vortex whip includes two constituent vortices with opposing senses of rotation, forming a downdraft between the two constituent vortices.

The vortex generator 640, by contrast, includes two sets of three vanes, each set including one or more negative-a vanes 645 and one or more positive-a vanes 650 and 655. As described in more detail in reference to FIG. 4, a set of three vanes of differing a-values will generate a vortex whip including three constituent stream-wise vortices that transfer energy from the strongest vortex to the weakest vortex, pushing the weakest vortex closer to the internal surface of the nozzle 605. In this way, the vortex generator 640 is configured to generate two parallel vortex whips, each including three constituent vortices. To reduce the interaction between the vortex whips, which may destabilize the individual vortex whips, the vanes may be oriented relative to the flow direction such that the vortex whips are mirrored. As illustrated, two positive-a are disposed next to two negative-a vanes on the internal surface of the nozzle 605.

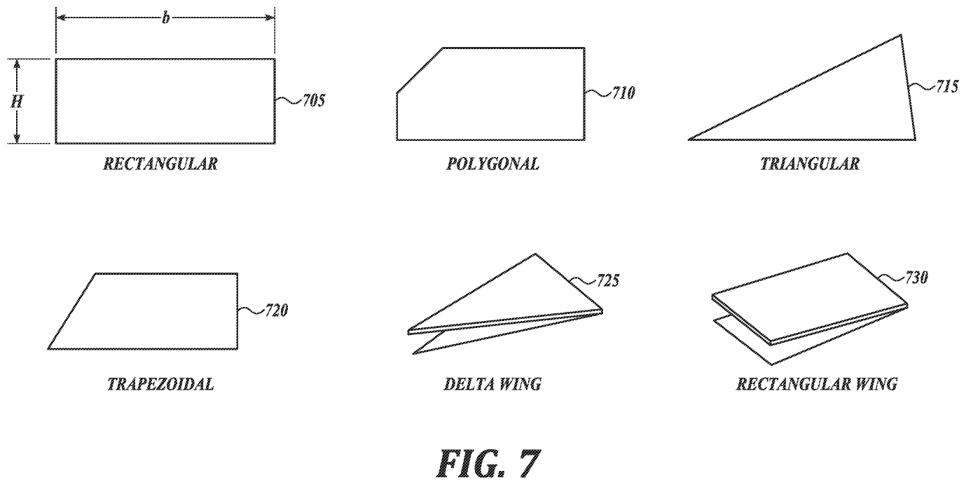

While the vanes are illustrated as quadrilateral in cross-section, this is shown for simplicity and clarity of explanation, and is not intended to be limiting. Instead, multiple vane geometries are contemplated, as illustrated in FIG. 5, and FIG. 7, below. Additionally or alternatively, vortex generators may incorporate alternative techniques for generating stream-wise vorticity into the fluid flow.

FIG. 7, is a schematic diagram illustrating example configurations for vane-type vortex generators, in accordance with various embodiments. Among the available vane geometries and configurations for vortex generators, such as vortex generator(s) 225 of FIG. 2A or vortex generator(s) 315 of FIG. 3, vane configurations may include, but are not limited to rectangular 705, polygonal 710, triangular 715, trapezoidal 720, delta wing 725, and/or rectangular wing 730 geometries.

Vane geometry serves a function, in that some vane geometries are better suited for particular flow conditions. For example, triangular 715 or delta wing 725 geometries may be suited to form stream-wise vortices in relatively high velocity fluid flow, attributable in part to reduced drag and/or disruption of the flow profile of the oncoming fluid flow. Conversely, rectangular 705 or rectangular wing 730 geometries may be suited to low velocity fluid flow, attributable in part to increased surface area providing increased deflection of flow in the lateral direction. Other geometries, including but not limited to polygonal 710 and trapezoidal 720 geometries may be suited for intermediate conditions between those suited to triangular 715 and those suited to rectangular 705 geometries. In this way, the vortex devices described herein (e.g., vortex device(s) 115 of FIG. 1) may include different vane geometries for different applications, depending, for example, on the ambient pressure, the fluid flow generated, a target flow velocity at the exit of a nozzle, etc.

FIG. 8, is a schematic diagram illustrating an example alternative technology for vortex generators, in accordance with various embodiments. While description of embodiments has focused on vane-type vortex generators, alternative technologies and techniques for vortex generation are contemplated in some embodiments. For example, a plasma actuator 800 applies lateral electrostatic force to a fluid flow “U” that induces stream-wise vorticity downstream of the plasma actuator 800. In some embodiments, the plasma actuator 800 is disposed in or on the internal surface of a nozzle 805 and, when energized, forms a stream-wise vortex 810 characterized by a sense of rotation opposite the direction of the electrostatic force applied by the plasma actuator 800. The plasma actuator 800 is illustrated as a dielectric barrier discharge system, including a first electrode 815, a second electrode 820 separated from the first electrode 815 by a dielectric barrier material 825, where the first electrode 815 and the second electrode 820 are electrically coupled via a power supply 830. While the power supply 830 is shown as an alternating current source, the power supply 830 may be or include a pulsed direct current source, and the second electrode 820 may be grounded to serve as a reference electrode. In some embodiments, the dielectric barrier material 825 is the nozzle 805.

The plasma actuator 800 may be or include one or more plasma configurations, such as dielectric barrier discharge, corona discharge, or other plasma system types that are suited to operation at or near atmospheric pressure. Advantageously, plasma-based vortex generators are less intrusive than vane-type generators, incurring a lower drag penalty that can reduce the exit velocity from the nozzle. Disadvantageously, plasma-based vortex generators consume power to generate a discharge 835, which reduces the energy efficiency of the overall vortex device. A balance exists in that a convector (e.g., convector 215 of FIG. 2A) may draw more power to compensate for the increased drag penalty of using vane-type vortex generators to provide the same exit velocity. In this way, the plasma actuator 800 may be more efficient under some conditions, such as high velocity conditions where the drag penalty of vane-type vortex generators exceeds the power drawn to generate the discharge 835.

Alternative technologies are contemplated for vortex generation, in addition to or alternatively to vane-type or plasma-based approaches. For example, pneumatic jets are an alternative technique, where fluid is pushed from outlets provided in the internal surface of the nozzle 805. A vortex whip including counter-rotating stream-wise vortices may be generated by ejecting multiple jets from the internal surface of the nozzle 805 at controlled angles. Advantageously, plasma-based methods and fluid jet-based methods may be dynamically controlled, for example, by controlling the power provided to the discharge, or by controlling the velocity of the vortex generator jets. In contrast, vane-type generators may be statically installed, and calibrated to provide a vortex whip within a predetermined operating window.

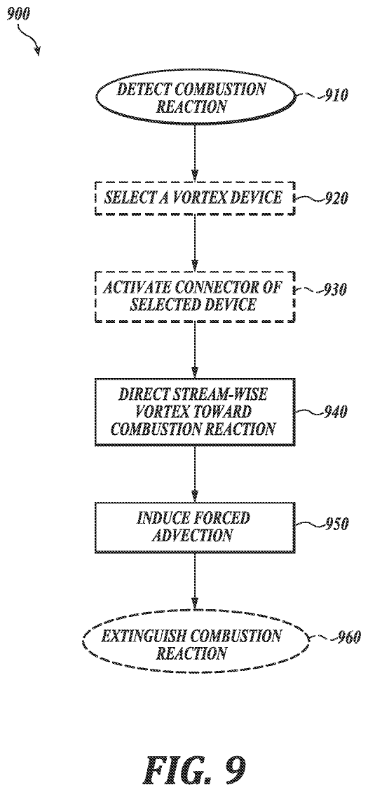

FIG. 9 is a flowchart that illustrates an example method 900 for extinguishing a fire, in accordance with various embodiments. The example method 900 may be performed by a computer system including one or more computing devices, such as control module 120 of FIG. 1 operably coupled with one or more vortex devices (e.g., vortex device(s) 115 of FIG. 1). The example method 900 may be stored as computer-executable instructions on a computer-readable memory device. In this way, the computer system may implement the operations of example method 900 as part of executing the instructions.

At operation 910, the example method 900 includes detecting a combustion reaction. As described in more detail in reference to FIG. 1 and FIG. 2A-2C, a vortex device (e.g., vortex device 115 of FIG. 1) may be included as part of an automated fire suppression system or may be a manually operated fire extinguisher, configured to generate a stream-wise vortex (e.g., vortex 230 of FIG. 2A), such as a vortex whip (e.g., vortex whip 420 of FIG. 4), from a nozzle (e.g., nozzle 205 of FIG. 2A). As part of implementing the vortex device to suppress and/or extinguish a combustion reaction on a surface of a material, operation 910 may include automated or human detection of the combustion reaction. In some embodiments, detection techniques may include hyperspectral imaging including infrared spectrum information to detect heat generated by the reaction and/or ultraviolet photons radiated by the reaction. In some embodiments, thermal sensors may include laser thermometry, rather than imaging approaches. In some embodiments, detection may include detection of visible flames, by automated sensors or by visual inspection.

Subsequent detection, the example method 900 may optionally include selecting a vortex device at operation 920. As described in more detail in reference to FIG. 1, a sensor and control network (e.g., sensor and control network 130 of FIG. 1) may include more than one vortex device. In this way, an automated system may be configured to select the nearest vortex device and/or the vortex device having the clearest line of sight to the location/position of the combustion reaction. As opposed to chemical fire retardants or techniques that involve flushing the environment of oxygen, a stream-wise vortex may exhibit improved results when the location of the combustion reaction (e.g., a “base” of a flame) can be targeted with the vortex directly. As such, the system (e.g., control module 120 of FIG. 1) may triangulate the location of the combustion reaction, for example, by comparing multiple sensor signals for a region of interest (e.g., region of interest 105 of FIG. 1) and may identify any obstructions that may reduce the effectiveness of the nearest vortex device.

Subsequent selection, the example method 900 may optionally include activating a convector (e.g., convector 215 of FIG. 2A) at operation 930. As described in more detail in reference to FIG. 1, activation may include an automated instruction generated by the control module to generate a fluid flow through a flow channel (e.g., flow channel 210 of FIG. 2A) in the nozzle of the selected vortex device. In some embodiments, when the vortex device is manually operated, operation 930 may include actuating manual controls (e.g., manual controls 240 of FIG. 2A). The active components of vortex devices may include, but are not limited to, the convector, vortex generators, or flow straighteners. For example, the vortex devices may incorporate control systems (e.g., control circuitry 235 of FIG. 2A) to facilitate active control and response to different combustion conditions. As an illustrative example, where one or more vortex generators are plasma-type vortex generators, the plasma system may operate with dynamic power and impedance matching subsystems (e.g., power supply 830 of FIG. 8). Similarly, vane-type vortex generators may be configured to controllably move in response to fluid flow velocity.

Subsequent activation, the example method 900 includes directing a stream-wise vortex toward the combustion reaction at operation 940. Directing the stream-wise vortex may include automated controls, such as moving a vortex device on a motor-controlled stage, as described in more detail in reference to FIG. 1 (e.g., as part of the operation of the sensor and control network). Additionally and/or alternatively, operation 940 may include manually positioning the vortex device such that the stream-wise vortex is directed toward the combustion reaction. As described in reference to FIGS. 3-8, the effect of the vortex is improved when the vortex is brought near the surface undergoing the combustion reaction, as described in reference to non-dimensional numbers relating the separation distance of constituent vortices and the height of the vortices from the surface of the nozzle. In this way, the operations of the example method 900 may include directing a vortex whip a predetermined distance from the surface undergoing the combustion reaction, in accordance with a calibrated energy transfer mechanism between the constituent vortices that increases the rotational velocity of one or more of the constituent vortices.

Subsequent directing the stream-wise vortex toward the combustion reaction, the example method 900 includes inducing forced advection near the surface of the material undergoing the combustion reaction at operation 950. In some cases, compressing the surface boundary layer, increasing advection near the surface, and/or increasing mixing at the surface, consistent with a Damköhler number on the order of one, may disperse volatile fuel near the surface and interrupt the propensity of the combustion reaction to self-sustain. In this way, a stream-wise vortex, such as a vortex whip (e.g., vortex whip 420 of FIG. 4), may reduce the effective Damköhler number at the surface of the material undergoing the combustion reaction to a value of ten or below.

Subsequent inducing advection, the example method 900 may optionally include extinguishing the combustion reaction at operation 960. The operations of the example method 900 are directed at a system for fire suppression, but it is understood that extinguishing the combustion reaction is a result of the example method 900, rather than a step to be actively taken. In this way, extinguishing the combustion reaction may include maintaining the advection induced at operation 950 until the combustion reaction is quenched.

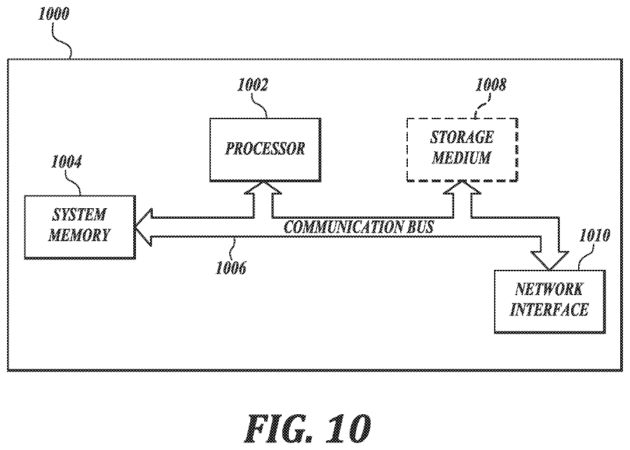

FIG. 10 is a block diagram that illustrates aspects of an example computing device 1000, in accordance with various embodiments. The exemplary computing device 1000 describes various elements that are common to many different types of computing devices, and may be an example of the control module 120 and/or communication module 125 of FIG. 1. While FIG. 1 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 1000 may be any one of any number of currently available or yet to be developed devices.

In its most basic configuration, the computing device 1000 includes at least one processor 1002 and a system memory 1004 connected by a communication bus 1006. Depending on the exact configuration and type of device, the system memory 1004 may be volatile or nonvolatile memory, such as read only memory (“ROM”), random access memory (“RAM”), EEPROM, flash memory, or similar memory technology. Those of ordinary skill in the art and others will recognize that system memory 1004 typically stores data and/or program modules that are immediately accessible to and/or currently being operated on by the processor 1002. In this regard, the processor 1002 may serve as a computational center of the computing device 1000 by supporting the execution of instructions.

As further illustrated in FIG. 10, the computing device 1000 may include a network interface 1010 comprising one or more components for communicating with other devices over a network. Embodiments of the present disclosure may access basic services that utilize the network interface 1010 to perform communications using common network protocols. The network interface 1010 may also include a wireless network interface configured to communicate via one or more wireless communication protocols, such as WiFi, 2G, 3G, LTE, WiMAX, Bluetooth, Bluetooth low energy, and/or the like. As will be appreciated by one of ordinary skill in the art, the network interface 1010 illustrated in FIG. 6 may represent one or more wireless interfaces or physical communication interfaces described and illustrated above with respect to particular components of the system 100.

In the exemplary embodiment depicted in FIG. 10, the computing device 1000 also includes a storage medium 1008. However, services may be accessed using a computing device that does not include means for persisting data to a local storage medium. Therefore, the storage medium 1008 depicted in FIG. 6 is represented with a dashed line to indicate that the storage medium 1008 is optional. In any event, the storage medium 1008 may be volatile or nonvolatile, removable or nonremovable, implemented using any technology capable of storing information including, but not limited to, a hard disk drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 1004 and storage medium 1008 depicted in FIG. 6 are merely examples of computer-readable media.

Suitable implementations of computing devices that include a processor 1002, system memory 1004, communication bus 1006, storage medium 1008, and network interface 1010 are known and commercially available. For ease of illustration and because it is not important for an understanding of the claimed subject matter, FIG. 10 does not show some of the typical components of many computing devices. In this regard, the computing device 1000 may include input devices, such as a keyboard, keypad, mouse, microphone, touch input device, touch screen, and/or the like. Such input devices may be coupled to the computing device 1000 by wired or wireless connections including RF, infrared, serial, parallel, Bluetooth, Bluetooth low energy, USB, or other suitable connections protocols using wireless or physical connections. Similarly, the computing device 1000 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the devices, methods, and systems described.

It is to be understood that the methods and systems described herein are not limited to specific methods, specific components, or to particular implementations. It is also to be understood that the terminology used herein is for the purpose of describing embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

1. A device for extinguishing fires, the device comprising:
a nozzle defining a flow channel;
a convector fluidly coupled with the flow channel and configured to introduce a flow through the flow channel; and
a vortex generator disposed within the nozzle, the vortex generator positioned to interact with the flow and to form a stream-wise vortex external to the nozzle.

2. The device of claim 1, wherein the vortex generator comprises a vane characterized by a long axis, wherein the flow is characterized by a flow direction, and wherein the long axis is angled relative to the flow direction by a nonzero angle of attack.

3. The device of claim 2, wherein the nozzle is characterized by a longitudinal axis parallel to the flow direction, wherein the vortex generator comprises a plurality of vanes, wherein each vane of the plurality of vanes is disposed within the nozzle at a position on the longitudinal axis, and wherein each vane is angled relative to the flow direction by a respective angle of attack.

4. The device of claim 3, wherein the plurality of vanes comprises a first vane, a second vane, and a third vane, each having a height “H” where H is a number, and wherein:
the first vane and the second vane are separated by a first distance, measured along an internal surface of the nozzle at the position, the first distance being defined by a first dimensionless ratio of the first distance and H from 0.01 to 1.00; and
the second vane and the third vane are separated by a second distance, measured along the internal surface of the nozzle at the position, the first distance being defined by a first dimensionless ratio of the first distance and H from 0.50 to 1.50.

5. The device of claim 3, wherein the stream-wise vortex comprises three constituent vortices, wherein a first constituent vortex of the three constituent vortices rotates in a first direction, and wherein a second constituent vortex and a third constituent vortex of the three constituent vortices rotate in a second direction, the second direction opposing the first direction.

6. The device of claim 2, wherein the vortex generator is a first vortex generator, the device further comprising a second vortex generator disposed within the nozzle, downstream from the first vortex generator relative to the flow direction.

7. The device of claim 6, wherein the first vortex generator comprises a first vane of a first size, and wherein the second vortex generator comprises a second vane of a second size.

8. The device of claim 7, wherein the first size is larger than the second size.

9. A system for extinguishing fires, comprising:
the device of claim 1, positioned proximal to a region of interest;
a sensor directed toward the region of interest;
a control module in electronic communication with the device;
one or more processors in electronic communication with the sensor and the control module; and
a non-transitory computer-readable medium storing instructions that, when executed by the one or more processors, cause the one or more processors to perform operations comprising:
detecting a combustion reaction in the region of interest using the sensor;
directing a stream-wise vortex from the device toward the combustion reaction using the control module; and
inducing forced advection at a surface undergoing the combustion reaction, such that the combustion reaction is characterized by a Damköhler number less than 10.

10. The system of claim 9, wherein the vortex generator comprises a dielectric barrier discharge source.

11. The system of claim 9, wherein the device is a first device, and wherein the system further comprises a second device in electronic communication with the one or more processors via the control module, the second device comprising:
a second nozzle, disposed in a second position relative to the region of interest; and
a second vortex generator, disposed within the second nozzle, the second vortex generator positioned to interact with a second flow and to form a second stream-wise vortex external to the second nozzle.

12. The system of claim 11, wherein directing the stream-wise vortex toward the combustion reaction using the control module comprises:
selecting the first device or the second device; and
activating a convector of the selected device to generate the flow.

13. A method of extinguishing a fire, the method comprising:
generating a flow characterized by a stream-wise vortex;
directing the flow toward a material undergoing a combustion reaction; and
inducing forced advection at the material, such that the combustion reaction is characterized by a Damköhler number less than 10.

14. The method of claim 13, wherein generating the flow comprises:
drawing a gas from the ambient environment or from a compressed gas source; and
flowing the gas through a flow straightener.

15. The method of claim 14, wherein the ambient environment is a microgravity environment.

16. The method of claim 13, wherein the flow is an air flow.

17. The method of claim 13, further comprising detecting the combustion reaction in a region of interest using a sensor.

18. The method of claim 13, wherein generating the flow comprises:
introducing the flow to a nozzle; and
interacting the flow with a vortex generator disposed within the nozzle, the vortex generator positioned to form the stream-wise vortex external to the nozzle.

19. The method of claim 18, wherein the vortex generator comprises a vane characterized by a long axis, wherein the flow is characterized by a flow direction, and wherein the long axis is offset from the flow direction by a nonzero angle of attack.

20. The method of claim 19, wherein the nozzle is characterized by a longitudinal axis parallel to the flow direction, wherein the vortex generator comprises a plurality of vanes, wherein each vane of the plurality of vanes is disposed within the nozzle at a position on the longitudinal axis, and wherein each vane is angled relative to the flow direction by a respective angle of attack.

21. The method of claim 13, wherein the vortex generator is a first vortex generator, and wherein a second vortex generator is disposed within the nozzle downstream from the first vortex generator relative to the flow direction.
